(19) United States
(12) Patent Application Publication
(10) Pub. No.: US 2024/0167119 A1
(43) Pub. Date: May 23, 2024

(54) TREATMENT OF HYDROUS ORE MATERIALS

(71) Applicant: AFRICAN RAINBOW MINERALS LIMITED, Sandton (ZA)

(72) Inventor: Gerard PRETORIUS, Pretoria (ZA)

(21) Appl. No.: 18/283,888

(22) PCT Filed: Mar. 31, 2022
(86) PCT No.: PCT/IB2022/053011

§ 371 Date: Sep. 25, 2023

(30) Foreign Application Priority Data
Mar. 31, 2021 (NL) 2027874

(51) Int. Cl. C22B 3/44; C22B 3/22

(52) U.S. Cl. CPC C22B 3/44; C22B 3/22

(57) ABSTRACT

A method of treating a hydrous ore material metal values includes a digestion step in which a solution of ferrous chloride (FeCl₂) and a divalent chloride of the at least one other metal (M²+Cl₂) is produced by contacting the hydrous ore material with gaseous hydrochloric acid. In a crystallisation step, crystallising a solid ferrous chloride hydrate (FeCl₂·xH₂O, wherein x>1) and a solid divalent chloride hydrate of the at least one other metal (M²+Cl₂·zH₂O, wherein z≥1) from the solution. In a dehydration step, the FeCl₂·xH₂O and the M²+Cl₂·zH₂O are subjected to temperature treatment to produce FeCl₂·yH₂O, wherein x>y>0, and M²+Cl₂·aH₂O, wherein z>a≥0. In a thermal decomposition step, the FeCl₂·yH₂O is 0 decomposed to produce anhydrous gaseous hydrochloric acid (HCl), which is used as the digestion reagent in the digestion step.

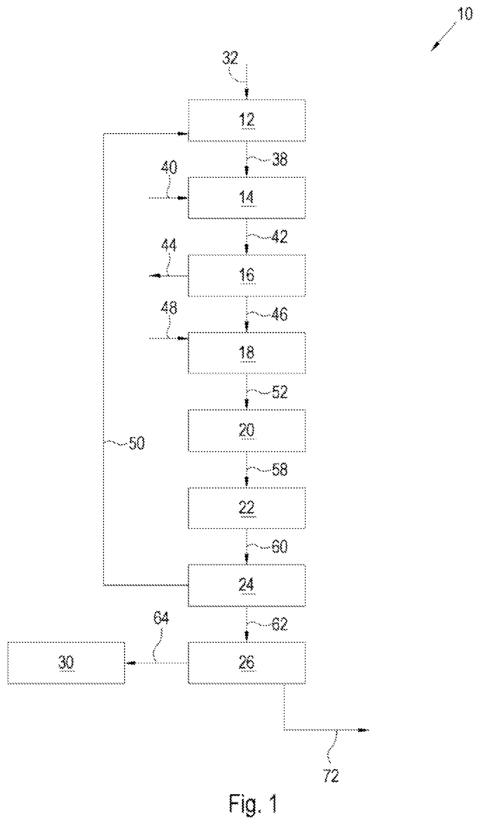

### FIELD OF THE INVENTION

THE INVENTION relates to the treatment of hydrous ore materials to liberate metal values contained therein. The invention provides a method of treating a hydrous ore material and extends to a process of treating a hydrous ore material.

### SUMMARY OF THE INVENTION

IN THIS SPECIFICATION the provision of features in parenthesis contribute to the substantive content of the specification and therefore to the characterisation of the invention. In particular, in cases in which generic chemical formulae and numerical values for symbols of such generic formulae are provided in parenthesis, this should be interpreted as contributing substantively to the characterisation of the invention.

IN ACCORDANCE WITH THE INVENTION IS PROVIDED a method of treating a hydrous ore material that comprises iron (Fe), in metallic or compound form, and at least one other metal (M), in metallic or compound form, to recover the iron and the at least one other metal from the hydrous ore material separately of each other, in metallic or compound form, the method including
in a digestion step, producing a solution of ferrous chloride (FeCl₂) and a divalent chloride of the at least one other metal (M²⁺Cl₂) (FeCl₂-M²⁺Cl₂ solution) by contacting the hydrous ore material with a digestion reagent in the form of gaseous hydrochloric acid (HCl), and reducing any ferric iron (Fe³⁺) in solution, typically present as FeCl₃, to ferrous iron (Fe²⁺) in solution, typically present as FeCl₂, using a reducing agent;
in a crystallisation step, crystallising a solid ferrous chloride hydrate (FeCl₂·xH₂O, wherein x≥1, more preferably x>1, x preferably being 4) and a solid divalent chloride hydrate of the at least one other metal (M²⁺Cl₂·zH₂O, wherein z≥1) from the FeCl₂-M²⁺Cl₂ solution;
in a dehydration step, subjecting the FeCl₂·xH₂O and the M²⁺Cl₂·zH₂O to temperature treatment to produce a solid partially dehydrated ferrous chloride hydrate (FeCl₂·yH₂O, wherein x>y>0, preferably being 1) and at least one of a solid partially dehydrated divalent chloride hydrate and a solid divalent chloride of the at least one other metal (M²⁺Cl₂·aH₂O, wherein z>a≥0);
in a thermal decomposition step, subjecting the FeCl₂·yH₂O and the M²⁺Cl₂·aH₂O to temperature treatment and thus decomposing the FeCl₂·yH₂O to produce solid ferric oxide (Fe₂O₃), gaseous hydrochloric acid (HCl), and solid divalent chloride of the at least one other metal (M²⁺Cl₂, i.e. wherein a=0); and
using the gaseous hydrochloric acid thus produced as the digestion reagent in the digestion step.

In the sense used in this specification, the term “hydrous ore material” means ore material that comprises chemically bound water (as opposed to “free water”, i.e. water in the form of H₂O that is not chemically bound), typically in a range of from about 5% to about 70% by weight, e.g. comprised in metal hydrates and/or metal hydroxides contained in the ore. For example, the hydrous ore material may be a clay-based ore material, such as, in particular, a laterite ore material, e.g. limonite, saprolite etc.

Significantly, the method may be, and preferably is, subject to the proviso that the hydrous ore material is not subjected to a drying or dehydration operation prior to treatment thereof according to the method of the invention.

The hydrous ore material may comprise, in addition to chemically bound water, some free water.

For the purpose of performing the method, the hydrous ore material may include, for example, free water of up to 5% based on the weight of the hydrous ore material.

The method may therefore include a prior step of adding free water to the hydrous ore material, for the hydrous ore material used in the method to have a free water content of up to 5% based on the weight of the hydrous ore material.

Contacting the hydrous ore material with the digestion reagent may include, or may be preceded by, size reduction of the hydrous ore material. Size reduction of the hydrous ore material may be performed to increase the surface area of the hydrous ore material that is available to be contacted by the digestion reagent.

Thus, the method may include either subjecting the hydrous ore material to size reduction and, subsequently and separately, contacting the hydrous ore material with the digestion reagent, or it may include subjecting the hydrous ore material to size reduction while contacting the hydrous ore material with the digestion reagent.

Size reduction of the hydrous ore material may be effected through milling, e.g. using ceramic milling media, or through shredding, slicing, breaking, crushing, or any similar size-reducing action.

It is noted that, in treating hydrous ore materials of the type to which the invention relates, size reducing operations such as milling are atypical, particularly insofar these may be applied to such ore materials before they are subjected to dehydration which, as mentioned above, the present invention seeks to avoid.

Reduction of ferric iron in solution to ferrous iron in solution will only be performed if there is any ferric iron in solution. In the case of laterite ore materials, it is expected that ferric iron in solution would be produced by the digestion step.

The crystallisation step may, for example, be performed as an evaporative crystallisation step, i.e. by evaporating water from the FeCl₂-M²⁺Cl₂ solution and thus cause crystallisation of the FeCl₂·xH₂O and the M²⁺Cl₂·zH₂O.

The at least one other metal may comprise one or more of copper (Cu), nickel (Ni), and cobalt (Co), in a metallic or compound form. Typically, the other metal would at least be nickel.

Preferably, the hydrous ore material may be ore from a lateritic nickel ore resource, e.g. a saprolitic nickel ore resource.

Depending on the composition of the hydrous ore material, the FeCl₂-M²⁺Cl₂ solution may therefore contain, in addition to FeCl₂, NiCl₂ and, possibly, CuCl₂ and/or COCl₂. Other metals may also be included.

The digestion step may be performed at a temperature of from 10° C. to 120° C.

Metallic iron may be used as the reducing agent.

In using metallic iron as the reducing agent, in addition to reduction of Fe³⁺ to Fe²⁺, other metals may be reduced, possibly to solid metallic form, thus rendering such metals readily recoverable by solid-liquid separation from the FeCl₂-M²⁺Cl₂ solution.

The method may include, in a first separation step performed after the digestion step, separating solids from the FeCl₂-M²⁺Cl₂ solution by means of solid-liquid separation, thus recovering the FeCl₂-M²⁺Cl₂ solution substantially free of solids.

The FeCl₂·xH₂O may, in particular, be FeCl₂·4H₂O (ferrous chloride tetrahydrate).

The method may include, in a second separation step, performed after the crystallisation step and before the dehydration step, recovering the solid FeCl₂·xH₂O and the solid M²⁺Cl₂·zH₂O from the crystallisation step. Such separation may be from residual liquid in the crystallisation step, if any.

The dehydration step may include subjecting the solid FeCl₂·xH₂O and the solid M²⁺Cl₂·zH₂O to temperature treatment to produce the solid FeCl₂·yH2O and the solid M²⁺Cl₂·aH₂O.

The FeCl₂·yH₂O may, in particular, be FeCl₂·H₂O (ferrous chloride monohydrate), i.e. y=1.

The temperature treatment in the dehydration step may include subjecting the FeCl₂·xH₂O and the M²⁺Cl₂·zH₂O to a temperature in a range of from 70° C. to 200° C., more preferably in a range of from 70° C. to less than 200° C., i.e. at a temperature less than 200° C. but not lower than 70° C. For example, the temperature may be a temperature in a range of from 70° C. to 150° C.

The dehydration step may be performed under non-oxidising conditions. This may include avoiding, or at least limiting, the presence of exogenous oxygen in the drying step. This may, in turn, include performing the dehydration step under positive pressure in a steam environment, which steam may be that which is produced as a result of the dehydration of the FeCl₂·xH₂O and the M²⁺Cl₂·zH₂O to produce the FeCl₂·yH₂O and the M²⁺Cl₂·aH₂O.

In the thermal decomposition step, any M²⁺Cl₂·aH₂O (wherein a≥1) produced in the dehydration step would be fully dehydrated, i.e. to form M²⁺Cl₂·aH₂O (wherein a=0). Thus, solid product emanating from the decomposition step would, in addition to the ferric oxide, include only M²⁺Cl₂·aH₂O (wherein a=0), i.e. M²⁺Cl₂, comprising any M²⁺Cl₂·aH₂O (wherein a=0) that was produced in the dehydration step and any M²⁺Cl₂·aH₂O (wherein a=0) that was produced in the thermal decomposition step.

The thermal decomposition step may be performed at a temperature of from 200° C. to 600° C., more preferably at a temperature above 200° C., up to 600° C.

The thermal decomposition step may be performed under oxidising conditions, i.e. in the presence of oxygen which may be supplied, for example, by air.

The gaseous HCl that is produced in the thermal decomposition step may be substantially dry, i.e. devoid of moisture (i.e. anhydrous).

Reactions that occur in the drying (dehydration) and thermal decomposition steps therefore comprise
(i) Drying (dehydration) at temperatures described above, under non-oxidising conditions

FeCl₂·4H₂O (s)→FeCl₂·H₂O (s)+3H₂O (g)
(ii) Thermal decomposition under oxidising conditions, in the presence of oxygen (½O₂) supplied by air, at temperatures described above

2FeCl₂·H₂O (s)→Fe₂O₃ (s)+4HCl (g)

As alluded to above, the temperature at which temperature treatment is performed in the thermal decomposition step may be selected such that thermal decomposition of FeCl₂·yH₂O occurs and thermal decomposition of the M²⁺Cl₂·aH₂O does not occur, i.e. such that thermal decomposition FeCl₂·yH₂O occurs to the exclusion of the M²⁺Cl₂·aH₂O, while any M²⁺Cl₂·aH₂O (wherein a≥1) becomes fully dehydrated to produce solid M²⁺Cl₂.

Therefore, in such a case, the thermal decomposition step would produce a mixture of solid Fe₂O₃ and solid M²⁺Cl₂, in addition to the HCl gas.

The method may then include, in a third separation step, dissolving the M²⁺Cl₂ in water, and performing a solid-liquid separation to recover the Fe₂O₃ from the resulting solution, thus recovering the at least one other metal and the iron separately of each other.

From the resulting M²⁺Cl₂ solution, such other metals may then be recovered by conventional methods, e.g. hydrometallurgical methods.

The method thus also produces saleable Fe₂O₃ and products suitable for recycle to earlier method steps. Most notably in this regard, it is noted that the thermal decomposition of FeCl₂·yH₂O by means of temperature treatment releases anhydrous HCl gas. The method therefore includes recycling this HCl gas to and using this HCl gas in the digestion step as the digestion reagent.

It is regarded as a particular advantage, and inventive feature, of the invention as described, that the production of FeCl₂·xH₂O and subsequent dehydration thereof to FeCl₂·yH₂O enables, through subsequent decomposition of the partially dehydrated FeCl₂·yH₂O, the production of HCl in gaseous form which is, as will be appreciated, concentrated, undiluted, and anhydrous HCl. This is in stark contrast to conventional methods exploiting HCl, which unavoidably form dilute solutions of HCl due to water balances that are unfavourable to the production of concentrated HCl, and even to the production of desired concentrations of diluted HCl. For example, while the maximum concentration of HCl at room temperature is around 33% v/v, existing methods exploiting HCl rarely achieve a regeneration of diluted HCl above 18% v/v. The present invention addresses this elegantly, by taking a route of iron precipitation as FeCl₂·xH₂O, partial dehydration thereof to produce FeCl₂·yH₂O, and decomposition thereof in turn to produce undiluted gaseous HCl for use in earlier method steps.

THE INVENTION EXTENDS TO a process for performing the method of the method of the invention, which process includes process stages and process operations corresponding to and for performing the respective method steps.

### DETAILED DESCRIPTION OF AN ILLUSTRATIVE EMBODIMENT

THE INVENTION WILL NOW BE DESCRIBED IN MORE DETAIL with reference to the accompanying diagrammatic drawing which shows a process according to the invention.

Referring to the drawing, reference numeral 10 generally indicates a process according to the invention, for performing a method of the invention.

The process 10 includes the following process stages:
an oxidative/reductive digestion stage 12;
a reduction stage 14;
a first separation stage 16;
a crystallisation stage 18;
a second separation stage 20;
a drying stage 22;
a thermal decomposition stage 24;
a third separation stage 26;
a metals recovery stage 30.

In the process 10, the following feed, transfer, withdrawal, and recycle lines are identified:
feed line 32;
transfer line 38;
feed line 40;
transfer line 42;
withdrawal line 44;
transfer line 46;
heating line 48;
recycle line 50;
transfer line 52;
recycle line 56;
transfer line 58;
transfer line 60;
transfer line 62;
transfer line 64;
transfer line 66;
recycle line 70;
withdrawal line 72; and
feed line 74.

In using the process 10 to perform the method of the invention, a hydrous ore material is fed to the digestion stage along feed line 32 and is, in the digestion stage 18, subjected to milling in a mill and, in doing so, is upgraded to a water content of 5% w/w free water by the addition of water. The hydrous ore material is then contacted with anhydrous gaseous hydrochloric acid in the mill, while being subjected to milling, along recycle line 50, such gaseous hydrochloric acid being produced as hereinafter described.

Digestion of the hydrous ore material proceeds in the digestion stage 12 to produce a FeCl₂—M²⁺Cl₂ solution, wherein M comprises Ni and possibly one or more of Co and Cu. If the hydrous ore material is a laterite ore material, the digestion stage 12 may first typically produce ferric iron as FeCl₃, requiring reduction thereof to FeCl₂.

The solution produced by the digestion stage 12 is thus transferred from the digestion stage 12 to the reduction stage 14 along transfer line 38, where it is contacted with a reducing agent that is fed to the reduction stage 14 along feed line 40, preferably being in the form of elemental iron or a source of ferric iron (e.g. Fe₂O₃), to produce the FeCl₂-M²⁺Cl₂ solution.

The FeCl₂-M²⁺Cl₂ solution is then transferred from the reduction stage 14 to the first separation stage 16 along transfer line 42, where solids contained in the FeCl₂-M²⁺Cl₂ solution are separated from the FeCl₂-M²⁺Cl₂ solution and are withdrawn along withdrawal line 44.

The recovered FeCl₂-M²⁺Cl₂ solution is then passed from the first separation stage 16 to the crystallisation stage 18 along transfer line 46. Here, solid FeCl₂·xH₂O (x≥1, more preferably x>1) and solid M²⁺Cl₂·zH₂O (z≥1) are crystallised from the FeCl₂-M²⁺Cl₂ solution through evaporative crystallisation by the addition of heat, as represented by heating line 48.

Typically, the value of x would be 4, and therefore the solid FeCl₂·xH₂O would be FeCl₂·4H₂O (i.e. ferrous chloride tetrahydrate).

The solid FeCl₂·xH₂O and the solid M²⁺Cl₂·zH₂O, in aqueous suspension, are then transferred to the second separation stage 20, along transfer line 52, where the solid FeCl₂·xH₂O and solid M²⁺Cl₂·zH₂O are recovered from residual liquid and are withdrawn along transfer line 58. The solid FeCl₂·xH₂O and the solid M²⁺Cl₂·zH₂O are then transferred to the dehydration stage 22 along transfer line 58. Of course, if there is no residual liquid from which to recover the solid FeCl₂·xH₂O and solid M²⁺Cl₂·zH₂O, then the second separation stage 20 may be omitted.

In the dehydration stage 22, the solid FeCl₂·xH₂O and solid M²⁺Cl₂·zH₂O are subjected to dehydration in a non-oxidising environment, using temperature treatment at a temperature below 200° C. but not less than 70° C., more preferably a temperature in a range of 70° C. to 150° C., thus producing solid FeCl₂·yH₂O and solid M²⁺Cl₂·aH₂O (x>y≥0; z>a≥0, wherein y is preferably 1).

More specifically, the solid FeCl₂·xH₂O and solid M²⁺Cl₂·zH₂O are fed into, and through once converted, a non-vented vessel in which the temperature treatment is carried out, thus producing a positive pressure inside the vessel resulting from steam that is formed inside the vessel due to the temperature treatment and the resulting dehydration of the FeCl₂·xH₂O at least, which steam serves to displace oxygen that may be present in the vessel, e.g. in the form of air, thus avoiding oxidisation of the ferrous chloride.

The solid FeCl₂·yH₂O and the solid M²⁺Cl₂·aH₂O are transferred, along transfer line 60, to the thermal decomposition stage 24, in which the solid FeCl₂·yH₂O and the solid M²⁺Cl₂·aH₂O are subjected to temperature treatment to decompose the solid FeCl₂·yH₂O to produce solid Fe₂O₃ and anhydrous HCl gas, to the exclusion of the solid M²⁺Cl₂·aH₂O which is not decomposed but is fully dehydrated, to the extent that it was not fully dehydrated already, to M²⁺Cl₂ (i.e. a=0). The temperature treatment is therefore effected under conditions that favour the thermal decomposition of FeCl₂·yH₂O over that of M²⁺Cl₂·aH₂O. The temperature treatment in the thermal decomposition stage 24 is performed at a temperature above 200° C., but not higher than 600° C., under oxidising conditions, i.e. in the presence of oxygen, e.g. being supplied by air.

The HCl gas produced in the thermal decomposition stage 24 is recovered and is recycled along recycle line 50 to the digestion stage 18, to be used as digestion reagent.

Thus, the process as described enables the achievement of a favourable water balance that, in turn, enables the production of concentrated substantially dry (anhydrous) HCl in gaseous form, for use upstream in the process. This is in contrast to existing processes that exploit HCl in metal recovery operations, which produce diluted HCl solutions, rarely at concentrations higher than 18% v/v.

In the absence of dehydration, the gaseous HCl produced from the thermal decomposition stage 24 would be moist/dilute (i.e. contain water vapour), which would not be effective to be exploited in the digestion stage 12 in the manner described above.

The solid Fe₂O₃ and solid M²⁺Cl₂·aH₂O are transferred to the third separation stage 26, along transfer line 62, in which the solid M²⁺Cl₂ (i.e. a=0) is dissolved in water to produce a M²⁺Cl₂ solution, and solid-liquid separation is carried out to recover the M²⁺Cl₂ solution and solid Fe₂O₃.

The M²⁺Cl₂ solution is transferred to the metals recovery stage 30 along transfer line 64, for recovery of the metals contained therein.

The Fe₂O₃ is withdrawn, as a saleable product, along withdrawal line 72.

### DISCUSSION

The applicant has surprisingly found that the chemically bound water comprised in hydrous ore materials may, possibly with the addition of a small amount of free water to wet the hydrous ore material, in the quantities described, be exploited to facilitate processing of such ore materials with gaseous hydrochloric acid that may then be regenerated as described, thereby to recover, separately, iron and other metal values from the hydrous ore material.

1. A method of treating a hydrous ore material that comprises iron (Fe), in metallic or compound form, and at least one other metal (M), in metallic or compound form, to recover the iron and the at least one other metal from the hydrous ore material separately of each other, in metallic or compound form, the method including
in a digestion step, producing a solution of ferrous chloride (FeCl₂) and a divalent chloride of the at least one other metal (M²⁺Cl₂) (FeCl₂-M²⁺Cl₂ solution) by contacting the hydrous ore material with a digestion reagent in the form of gaseous hydrochloric acid (HCl), and reducing any ferric iron (Fe³⁺) in solution, present as FeCl₃, to ferrous iron (Fe²⁺), present as FeCl₂ in solution, using a reducing agent;
in a crystallisation step, crystallising a solid ferrous chloride hydrate (FeCl₂·xH₂O, wherein x>1) and a solid divalent chloride hydrate of the at least one other metal (M²⁺Cl₂·zH₂O, wherein z≥1) from the FeCl₂-M²⁺Cl₂ solution;
in a dehydration step, subjecting the FeCl₂·xH₂O and the M²⁺Cl₂·zH₂O to temperature treatment to produce a solid partially dehydrated ferrous chloride hydrate (FeCl₂·yH₂O, wherein x>y>0) and at least one of a solid partially dehydrated divalent chloride hydrate and a solid divalent chloride of the at least one other metal (M²⁺Cl₂·aH₂O, wherein z>a≥0);
in a thermal decomposition step, subjecting the FeCl₂·yH₂O and the M²⁺Cl₂·aH₂O to temperature treatment and thus decomposing the FeCl₂·yH₂O to produce solid ferric oxide (Fe₂O₃), anhydrous gaseous hydrochloric acid (HCl), and solid divalent chloride of the at least one other metal (M²⁺Cl₂, i.e. wherein a=0); and
using the anhydrous gaseous hydrochloric acid thus produced as the digestion reagent in the digestion step.

2. The method according to claim 1, wherein contacting the hydrous ore material with the digestion reagent includes, or is preceded by, size reduction of the hydrous ore material, which size reduction is performed to increase a surface area of the hydrous ore material that is available to be contacted by the digestion reagent.

3. The method according to claim 2, wherein contacting the hydrous ore material with the digestion reagent is performed simultaneously with performing size reduction of the hydrous ore material.

4. The method according to claim 1, wherein the at least one other metal is selected from one or more of copper (Cu), nickel (Ni), and cobalt (Co), in a metallic or compound form.

5. The method according to claim 1, wherein the hydrous ore material is a lateritic ore material.

6. The method according to claim 1, wherein the crystallisation step is an evaporative crystallisation step.

7. The method according to claim 1, which includes, in a first separation step performed after the digestion step, separating, using solid-liquid separation, solids from the FeCl₂-M²⁺Cl₂ solution, thus recovering the FeCl₂-M²⁺Cl₂ solution substantially free of solids.

8. The method according to claim 1, which includes, in a second separation step, performed after the crystallisation step and before the dehydration step, recovering the solid FeCl₂·xH₂O and the solid M²⁺Cl₂·zH₂O from the crystallisation step.

9. The method according to claim 1, wherein the dehydration step is performed under non-oxidising conditions at a temperature in a range of from 70° C. to 150° C.

10. The method according to claim 1, wherein the thermal decomposition step is performed under oxidising conditions at a temperature of from 200° C. to 600° C.
